(19) United States
(12) Patent Application Publication
(10) Pub. No.: US 2007/0033200 A1
(43) Pub. Date: Feb. 8, 2007

(54) Smart folder software

(76) Inventor: David Gillespie, Cannon Hill (AU)

Correspondence Address: EDWIN D. SCHINDLER, FIVE HIRSCH AVENUE, P.O. BOX 966, CORAM, NY, 11727-0966, US

(21) Appl. No.: 10/572,406

(22) PCT Filed: Sep. 17, 2004
(86) PCT No.: PCT/AU04/01275

§ 371 Date: Mar. 16, 2006

(30) Foreign Application Priority Data
Sep. 18, 2003 (AU) 2003905085

(51) Int. Cl. G06F 7/00

(52) U.S. Cl. 707/100

(57) ABSTRACT

A smart folder for a selected set of documents or records in a document management system, which documents or records have a unique identity, with the smart folder being associated with software for handling the documents or records in a substantially automated manner in accordance with predetermined rules associated with the selected set of documents or records.

### AREA OF THE INVENTION

This invention relates to computer software document management systems and in particular to such a management system which, given its knowledge of the type of documents presented to it is able to process these in an appropriate manner.

### BACKGROUND TO THE INVENTION

The basic function of document management software is to manage a document's lifetime from creation to destruction. In large organisations software is preferably designed to securely and dependably manage every electronic document produced with the enterprise and reliably retrieve those documents wherever and whenever required.

Such document management software typically has the following components, which are a database, a browser interface, a search interface and a method of intercepting file save and open calls.

Document management extension software merges the traditional functionality of index databases, file repositories and messaging systems and provides an efficient means for handling conventional documentation which is used by or disseminated to various members of a particular business community.

Other documents however may be of a particular type and need to be handled in accordance with a known set of rules. Such handling has in the past been effected by a person familiar with the requirements of a document or record as there has not been software which was able to recognise the document and automatically deal with it appropriately.

### OUTLINE OF THE INVENTION

It is an object of the invention to provide software for use with document management extension software said software being able to process a folder and its documents in accordance with specific rules known to be associated with that document.

In order to distinguish the document management software of the invention from earlier such software the term smart folder will be used to describe a document container used in association with this software.

The invention is a smart folder for a particular set of documents or records in a document management system, which have a unique identity, which smart folder is associated with software means for handling the documents or records in a generally automated manner which is in accordance with a known set of rules associated with those documents or records.

It is preferred that a smart folder is treated in the invention like any document or set of documents. It has a unique identity and can have document metadata associated with it including document type, status, keywords and custom properties.

It is further preferred that the folder can have permissions assigned to it which determine which users can modify or browse the folder, have access to its contents and add documents to the folder.

It is preferred that a smart folder can also be declared as a record and therefore have record retention information assigned to it as is possible with any document in the system.

It is preferred that the smart folder be able to contain one or more documents. It has a templating function which allows the owner of the smart folder to specify what document metadata and permissions are assigned to any documents stored in the folder. Users with appropriate permissions can therefore save documents into the folder and, at this point, the metadata and permissions specified in the template are applied to the documents on entry. Every document contained within a smart folder maintains a pointer to its parent folder.

It is also preferred that If a smart folder is declared a record then all documents contained in the folder are also declared as records. The retention of documents is driven by the retention information of their parent folder such that once the time specified for a document to be retained has elapsed it can be automatically removed.

It is preferred however that an individual record's retention information can be overridden with different retention information if so required.

It is preferred that a smart folder may become due for disposal when all contents of the folder are due. Thus the most severe retention date for any document in the folder in the system determines when the whole smart folder becomes due for disposal. When the folder is disposed of all the contents of the folder are also disposed of.

In order that the invention may be more readily understood a specific example of the invention will be described herein by way of non limiting example in association with the appended diagram.

### DESCRIPTION OF THE DRAWING FIGURE

FIG. 1 is a diagram showing a records management system that supports and leverages end users in their natural working practices and demonstrates the interaction with smart folders;

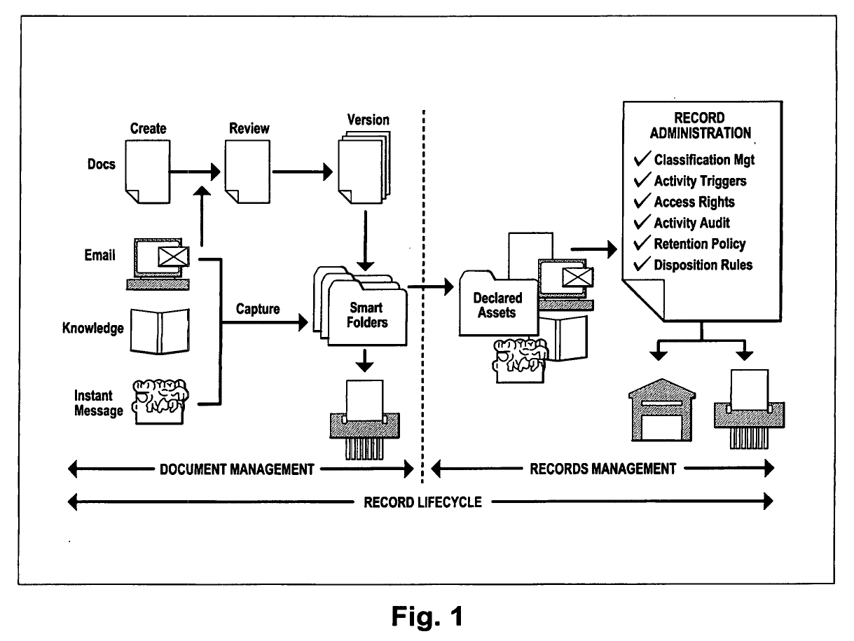

### BRIEF DESCRIPTION OF AN EMBODIMENT OF THE INVENTION

The document manager discussed in association with this example of the smart folders of the invention, as used by a company, will be described here and provides all the typical administration features needed in an electronic records management process and is compliant with the ISO 15489 standard.

A web based administration interface allows record managers to create and manage the company file plan which is usually made up of retention schedules linked to a hierarchical business classification scheme. The business classification scheme represents the company's set of functions and activities and is derived from a standard keyword AAA thesaurus. This file plan is published to the rest of the organization allowing users to classify and automatically applying retention policies on records.

Other record administration features include audit logging of record events, and the ability to run audit reports. A standard record report and searching interface allows the record manager to proactively manage the disposal of records, i.e. review and confirm the disposal of records.

The document manager manages the whole life cycle of records in the repository allowing documents to transition seamlessly from the document life cycle to the record lifecycle. Authors can easily declare and classify their documents as records by simply applying a record status to the document.

The desktop and application integration in the document manager enables users to create records from their desktop, supporting a non-centralized record creation process and harnessing the collective power of users within the organization. Because users can apply permissions to records, as with any other document in the system, record level security control is automatically provided.

To alleviate the complex decision making process of classifying records and applying the correct retention policy, the smart folders of the invention provide business owners with a mechanism to predetermine the retention policy and classification of records. In a similar fashion to the property template function, retention information can be assigned to the folder. Therefore, as users save a document into a smart folder, a retention policy is automatically applied.

The combined use of property and retention templates allow business activity templates to be defined which automatically execute tasks typically performed by special applications (matter, claims, project & case management) such as applying a project or claims reference number. This means records can be stored in a universal records repository rather than maintaining many separate stores or islands of information.

In the document manager described here, all documents are stored within one or more repositories. All information is searchable either via the metadata assigned to each of the documents or via a full text search of the actual content. However, in some cases, it might be useful to arrange documents within folders that may be arranged in some hierarchical form. The MS File System offers such a paradigm via the concept of hierarchical directories browse-able via client tool such as Windows Explorer. The advantage of such a paradigm is that it provides a search mechanism which is independent of any metadata associated with documents that live in these folders. Hence the introduction of the associated smart folders.

A smart folder is like a conventional windows folder, in that it contains documents which can only be located in one smart folder. However, this is where the similarities end. A smart folder is treated like any other document in the system. It has a unique identifier, and therefore lives within a specific repository; it has metadata associated with it, as well as permission information.

Users can be assigned a range of permissions for creating and/or browsing smart folders. Smart folders can be browsed and accessed by users via the standard document manager client interfaces including Find, Shell, Browser and ODMA Dialogs. Documents can be saved directly into the folder using the ODMA dialogs and Shell by browsing the smart folder hierarchy and selecting the appropriate folder to place the document in. Alternatively, users can drag a document from a search result, i.e. via saved search or ad hoc search, directly into a folder from within the Find client or Shell. The smart folder's property and record template capability means that documents saved into a folder will have document metadata and record disposition information automatically assigned.

Finally, smart folders can be declared as records in their own right. That is, retention and associated record information is assigned to the folder, and all documents added to this record folder are treated as sub records of the folder. Like other documents, a folder is declared a record via the folder properties dialog, i.e. assigning a record status to the folder, and specifying the record disposal information from the record tab. Such record folders, marked as “Open”, can have documents placed inside them by saving or dragging a document directly into the folder.

The documents placed within these record folders are therefore controlled by the retention policy associated with the folder. However, the retention information associated inherited from its parent record folder can also be overridden at the document level. Note, once a record folder is marked as “Closed”, users can no longer add new documents to the folder. Finally, the record folder can only be disposed of once all its items located within the folder become due for disposal. This ensures that records related to a particular matter or project will be disposed of together as a single record.

The availability of smart folders means that document profiling is controlled by business owners alleviating the need for end users to understand how their documents should be profiled. This is extremely applicable to areas such matter management, claims correspondence, project management and case management.

Smart folders also empower business owners to assign retention and categorization rules controlling how records are generated. The complexity of deciding what retention and categorization to apply to records is removed from end users. It also allows the assignment of record retention rules retrospectively which results in automatic record management. This greatly assists the record manager's role of implementing a successful record retention strategy within an organization.

Finally, smart folders facilitate the creation of documents and records by leveraging the natural working practices of users. Users are required to make the one decision they have always been making: where to put the document. By integrating with end users' natural habits, minimal training is required.

The features of the embodiment of the invention described represent a specific embodiment of the invention which lies in a document management system which deals with documents in accordance with a recognised set of appropriate rules.

It is envisaged however that other embodiments of the invention will exhibit any number of and any combination of the features of those previously described and whilst we have described herein one specific embodiment of the invention it is to be understood that variations and modifications in this can be made without departing from the spirit and scope thereof.

1-14. (canceled)

15. A smart folder for a selected set of documents or records having a unique identifier in a document management system, comprising:
a predetermined set of rules applicable for a selected set of documents or records; and,
software means for handling said selected set of documents or records.

16. The smart folder for a selected set of documents or records according to claim 15, wherein said smart folder contains at least one document or record of said selected set of documents or records.

17. The smart folder for a selected set of documents or records according to claim 15, further comprising document metadata for said selected set of documents or records.

18. The smart folder for a selected set of documents or records according to claim 17, wherein said document metadata includes at least one of document type, document status, keywords and custom properties.

19. The smart folder for a selected set of documents or records according to claim 15, further comprising a set of permissions assigned to said smart folder for determining users permitted to modify or browse said smart folder, have access to said smart folder or add documents to said smart folder.

20. The smart folder for a selected set of documents or records according to claim 15, further comprising software having record retention information means.

21. The smart folder for a selected set of documents or records according to claim 15, further comprising software means for an individual's record retention information to be overridden with software having different retention information, when so required.

22. The smart folder for a selected set of documents or records according to claim 15, further comprising software having a templating function for allowing an authorized person for said smart folder to specify document metadata and permissions to be assigned to any documents or records stored in said smart folder, so that other users of said smart folder, having valid permissions, are able to save documents or records into said smart folder.

23. The smart folder for a selected set of documents or records according to claim 22, wherein said document metadata and permissions specified in said software having said templating function includes means for applying said document metadata and permissions to the documents or records upon entry to said smart folder.

24. The smart folder for a selected set of documents or records according to claim 15, further comprising a pointer to a parent folder of said smart folder.

25. The smart folder for a selected set of documents or records according to claim 15, further comprising software means so that when a smart folder is declared a “record,” then all documents container in said smart folder are also declared “records.”

26. The smart folder for a selected set of documents or records according to claim 15, wherein said software means for handling a selected set of documents or records includes means for retaining document or records driven by retention information of a parent folder, so that once a predetermined period of time for a document or record to be retained has elapsed, the document or record is able to be automatically removed from said smart folder.

27. The smart folder for a selected set of documents or records according to claim 26, further comprising software means for disposal of the document or record that is automatically removed from said smart folder.

28. The smart folder for a selected set of documents or records according to claim 27, further comprising software means for retaining documents or records for which said predetermined period of time for the document or record to be retained has not elapsed.

29. The smart folder for a selected set of documents or records according to claim 15, further comprising software means for disposal of said smart folder, in its entirety, said software means for disposal of said smart folder effecting disposal of all documents and records in said smart folder.
